(19) United States
(12) Patent Application Publication
(10) Pub. No.: US 2011/0014327 A1
(43) Pub. Date: Jan. 20, 2011

(54) METHODS AND COMPOSITIONS FOR READY TO USE AQUATIC ANIMAL FOOD KEPT IN FROZEN STORAGE

(76) Inventors: Thomas K. Testa, Ogden, UT (US); Tim Troy, Ogden, UT (US)

Correspondence Address: THORPE NORTH & WESTERN, LLP., P.O. Box 1219, SANDY, UT, 84091-1219, US

(21) Appl. No.: 12/839,176

(22) Filed: Jul. 19, 2010

Related U.S. Application Data
(60) Provisional application No. 61/226,467, filed on Jul. 17, 2009.

(51) Int. Cl. A23K 3/00; A23K 1/00; A23K 1/10

(52) U.S. Cl. 426/92; 426/310; 426/305; 426/100

(57) ABSTRACT

A method for preserving aquatic animal feeds that are stored in frozen storage in a ready to use (pliable) state is disclosed and described. The method includes immersing ingredients into a propane polyol containing solution. The ingredients are maintained in the propane polyol containing solution for a period of time sufficient to allow the propane polyol to coat and penetrate into the ingredients and form propane polyol coated and impregnated aquatic animal food. The impregnated aquatic animal food can then be removed from the propane polyol containing solution and cooled. The propane polyol impregnated animal food remains pliable when cooled to a temperature of −15° C.

### RELATED APPLICATION

This application claims the benefit of U.S. Provisional Patent Application No. 61/226,467, filed Jul. 17, 2009 which is incorporated herein by reference.

### FIELD OF THE INVENTION

The present invention relates generally to methods of maintaining aquatic animal food in a ready to use (soft) state while under typical frozen storage conditions.

### BACKGROUND

Frozen seafood food is a common and convenient way to feed various animals, including carnivorous fish. Many animal-feed seafood products or seafood containing formulated diets are prepared as solid frozen blocks while others are individually glazed with water or other frozen coating solutions. The individually glazed seafood/food has a common tendency to re-agglomerate (or) to freeze together after even partially thawing during shipping to suppliers, while being transported from suppliers to the hobbyist or if left out during use. In many of these forms, the hard, frozen seafood/food may be thawed before delivery as food or served frozen. Packages of animal-feed seafood products (krill, brine shrimp, silversides, formulated feed, etc.) typically hold many meals (or) feedings. Multiple freeze-thaw sessions tends to result in oxidation and degrading of the essential nutrients in the un-fed, thawed food that is re-frozen. This may also result in the formation of anti-nutritional factors such as peroxides. Refreezing also generally causes individual pieces to become agglomerated into a larger solid body. In some cases, fracturing or chopping of a frozen block results in broken animal bodies (e.g. krill, fish, etc). Such segmented pieces can provide nutrients in incorrect proportions from natural presentation. Further, in aquaria, broken animal feed immediately and readily leach nutrients into the aquatic environment and can quickly degrade water quality. Additionally, frozen or partially frozen seafood can become lodged in the throats of the animals to which it is fed resulting in injury or death. Thus, the thawing process can be time consuming and cumbersome and can result breaking or damaging of the seafood and loss of essential nutrients that can create water quality problems when used. Accordingly, research continues into improved animal feed products kept in frozen storage and methods for making them.

### SUMMARY OF THE INVENTION

Aquatic animal food can be coated and infused or saturated with a palatable, nutritious anti-freeze which allows it to remain flexible during storage at typical industrial or residential freezer temperatures. Accordingly, a method of preserving various feed product for use as aquatic animal feed is provided. The method includes immersing an aquatic animal food into a propane polyol containing solution. The aquatic animal food is maintained in the propane polyol containing solution for a period of time sufficient to allow the propane polyol to penetrate into the food and form propane polyol impregnated and coated aquatic animal food. The impregnated food can then be removed from the propane polyol containing solution and cooled. The propane polyol impregnated aquatic animal food remains pliable when cooled to a temperature of −15° C.

In one embodiment of the above described method of preserving aquatic animal feed, the immersing step can further comprise creating a vacuum around the propane polyol containing solution. In one aspect, the vacuum can be from about 0.1 to about 1 bar. In another embodiment, the propane polyol impregnated animal food can include from 1 wt % to 20 wt % propane polyol.

The propane polyol impregnated animal food can remain soft and ready to eat while in frozen storage via infusion of the anti-freeze into and throughout the food. The food pieces do not stick to one another while in frozen storage and are also ready to use as feed.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### DETAILED DESCRIPTION

Before the present invention is disclosed and described, it is to be understood that this disclosure is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

As used in this specification and the appended claims, the singular forms “a,” “an,” and “the” include plural referents unless the context clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, “aquatic animal food” refers to food used for marine or freshwater animals. For example, such food can include, but is not limited to, seafood, terrestrial meal, and the like.

The term “propane polyol impregnated aquatic animal food” refers to any animal food that has been soaked in a propane polyol containing solution so as to allow propane polyol to penetrate into and be retained by the animal food. In one embodiment, propane polyol impregnated seafood can contain from 1.0 wt % to 20 wt % of propane polyol.

The term “raw seafood” refers to any sea organism, including wild or farmed, fresh water or salt water once living, such as fish, crustaceans including krill, shrimp, brine shrimp, mollusks, eggs or embryos, bivalves, plankton, macro-algae, crustaceans, worms, and the like, that has not been cooked or blanched.

The term “blanch” or “blanching” takes its ordinary meaning known in the art, namely the plunging of an item, such as raw seafood, into boiling water for a brief period of time, removing the item and then plunging the item into a cool liquid bath. Accordingly, the term “unblanched raw seafood” refers to seafood that has not been blanched.

The term “formulated feed” refers to an aquatic animal food which is formulated containing more than one ingredient; including, but not limited to raw seafood, blanched seafood, terrestrial meals, aquatic meals, binders, oils, vitamins, minerals, etc. that are combined.

The term “standard freezing technique” refers to cooling or freezing methodologies that are well known in the refrigeration industry such as by placement in a traditional freezer, passage through a freezing tunnel, flash freezing, or the like. It is noted that for the purpose of the present application individual quick freezing (IQF) is not considered to be a standard freezing technique.

As used herein, “vacuum” refers to a pressure which is less than ambient. Although other pressures can be used, 0.1 to about 0.5 bar can be effective.

As used herein, “whole” refers to unbroken seafood, i.e. which has not been crushed, sliced, broken or otherwise comminuted from a condition as the seafood was grown.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 20 wt %” should be interpreted to include not only the explicitly recited values of about 1 wt % to about 20 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The present disclosure is drawn to methods of preserving aquatic animal feed and associated preserved food products. It is noted that when discussing the present methods and associated products, each of these discussions can be considered applicable to each of these embodiments, whether or not they are explicitly discussed in the context of that embodiment. Thus, for example, in discussing a flavor enhancer used in the method of the invention, such a flavor enhancer can also be used in the preserved animal food products.

With the above definitions in mind, the present invention is drawn to a method for producing a convenient aquatic animal food, ready to use immediately after removing it from a frozen storage area. The method includes immersing an aquatic animal food such as unblanched seafood, blanched seafood or a formulated animal food (cooked, raw or dried), into a propane polyol containing solution. The aquatic animal food is maintained in the propane polyol containing solution for a period of time sufficient to allow the propane polyol to penetrate into the animal food and form propane polyol impregnated seafood. The impregnated aquatic animal food can then be removed from the propane polyol containing solution, drained and cooled. The propane polyol impregnated food remains pliable when cooled to a temperature of −15° C. In another embodiment, the present invention provides for a preserved aquatic animal food product prepared by the above described method.

The duration of the immersing of the raw seafood in the propane polyol containing solution can be sufficient to allow some propane polyol from the propane polyol containing solution to penetrate into and ultimately be retained by the aquatic animal food. The duration of time necessary to achieve the desired result can vary depending on a number variables including the type of food being immersed, the size or particle size, the temperature of the propane polyol containing solution, the concentration of the propane polyol in the propane polyol containing solution, and the pressure of the surrounding atmosphere. In one embodiment, the duration of the immersing step can be from 5 minutes to 120 minutes. In another embodiment, the duration of the immersing step can be from 15 minutes to 90 minutes. Although not required, the propane polyol containing solution can be maintained at a cool temperature. As a general guideline, a cool temperature can be from about 1° C. to about 10° C., such as about 3° C. to about 5° C.

In one embodiment, the immersing step can include the creation or drawing of a vacuum of from about 0.1 bar to about 1.0 bar around the seafood and the propane polyol containing solution. The creation of a vacuum during the immersing step can reduce the duration of time necessary to allow for sufficient penetration of the propane polyol into the aquatic animal food. In one embodiment, the vacuum can be from about 0.25 to about 0.75 bar. The desired vacuum pressure can vary depending on a number of factors such as the tissue texture, number in a batch, size of organisms to be preserved, temperature of the particular organism to be infused, particle size of the formulated food and temperature of the propane polyol solution. Application of vacuum pressure can maintain the integrity of the organism or maintain as many whole animals (non-ruptured carcasses) as possible. Further, vacuum pressure can enhance infusion of the solution such that the carcasses are well impregnated so to avoid any tissue freezing/hardening during frozen processing and storage. Vacuum can be maintained for a period of time which matches the immersion time or for a lesser period of time. As a general guideline, vacuum times can be from about 2-10 minutes such as about 5 minutes, although other times can be used. In another alternative (or in addition to the above), the vacuum can be maintained subsequent to immersion but prior to cooling.

Whether immersed under vacuum or under ambient pressure, the aquatic animal food can be impregnated with the propane polyol such that the final impregnated animal food can comprise 1 wt % to 20 wt % propane polyol. In one embodiment, the impregnated formulated feed can comprise 5 wt % to about 10 wt % of propane polyol. The percentage of propane polyol can vary depending on the particular type of animal food.

The propane polyol containing solution used can comprise at least 50 wt % propane polyol. In one embodiment, the propane polyol containing solution can comprise at least 90 wt % propane polyol. In one additional aspect, the propane polyol containing solution can consist essentially of propane polyol. The propane polyol can include glycerol, propylene glycol, 1,3-propanediol and combinations of these. In one aspect, the propane polyol can be a single component. In another alternative, the propane polyol can be a mixture of glycerol and propylene glycol.

In addition to propane polyol, the propane polyol containing solution can optionally include other compounds that can be impregnated into the animal food during practice of the method. In one embodiment, the propane polyol containing solution can include a flavor enhancer. Non-limiting examples of flavor enhancers and/or attractants that can be included in the propane polyol containing solution and impregnated into the animal food include betaine hydrochloride, free amino acids, fish hydrosylates, and combinations thereof. In one embodiment, the propane polyol containing solution can include betaine hydrochloride. In another embodiment, the propane polyol containing solution can include tryptophan. When included in the propane polyol containing solutions, the flavor enhancers also impregnate the animal food thereby enhancing the desirability of the food to the targeted animals to which the animal food will be fed. Other additives which can be included singly or in combination can include, but are not limited to, nutrients, preservatives, medicines, vitamins, and other enrichments such as highly unsaturated fatty acids, krill oil, threonine, etc., and the like. Regardless of the specific composition, the products can also be non-toxic.

These methods can be used with any type of animal food capable for use as aquatic animal feed. In one embodiment, the aquatic animal food can be a raw seafood selected from the group consisting of krill, shrimp, brine shrimp, bivalves, mollusks, worms, macro-algae, fish, seaweed, polychaetes, and other plankton and other common fish foods, and combinations thereof. In one embodiment, the raw seafood can be krill. In one aspect, the animal food can be whole. Alternatively, the animal food can be compound feed and/or subdivided pieces of the above listed ingredients. In another aspect, the animal food can be unblanched raw seafood, blanched seafood or a formulated animal food (cooked, raw or dried).

Once immersed in the propane polyol containing solution and impregnated with propane polyol, the impregnated aquatic animal food can be removed and be drip-dried, thereby allowing excess propane polyol containing solution to drip from the impregnated animal food. It is noted that drying, such as by drip-drying (with or with-out agitation) or by positive air-flow, is not required but can be beneficial in order to avoid significant residual buildup of excess propane polyol containing solution on the exterior of the impregnated animal food and to reduce process time and to reduce exposure time to process or room temperatures.

Once impregnated with propane polyol, the impregnated and coated aquatic animal food can be cooled using any cooling means known in the art. Generally, the impregnated animal food can be cooled using standard freezer freezing techniques. In one embodiment, the impregnated animal food is cooled using a tunnel freezer. In another embodiment, the impregnated animal food is packed prior to cooling.

The impregnated animal food has the ability to avoid agglomeration when frozen. Further, by avoiding IQF-type processes a thin film of ice can be avoided. In this manner, even if partially thawed and re-cooled the pieces remain individualized. For example, shrimp that are preserved through these methods tend not to adhere to each other when cooled and/or re-cooled to subfreezing temperatures but rather they remain individualized and free flowing even when packaged together. Such a characteristic is advantageous because it allows the end user to withdraw individual portions of the impregnated animal food for feeding without having to warm or thaw large portions, such as when frozen animal food is frozen into a block. Further, these methods allow for the impregnated seafood to remain pliable even when cooled to temperatures of −15° C. In many cases, refrigeration temperatures will be from about −10° C. to about 5° C., although about −2° C. is common. The pliability at such subfreezing temperatures allows the animal food to be safely fed to animals without thawing or warming. Aquatic animal food that is frozen solid and lacks pliability at low temperatures cannot be fed directly to animals without risking injury or death of the animal, such as by lodging in the animal's throat.

The following examples illustrate embodiments of the disclosure that are presently known. Thus, these examples should not be considered as limitations of the disclosure, but are merely in place to teach how to make compositions of the present disclosure. As such, a representative number of compositions and their method of manufacture are disclosed herein.

### EXAMPLES

### Example 1

### Impregnating Whole Raw Krill Using 100% Glycerol Solution

Drip dried whole raw krill are placed into a batch of 70° F., 100% glycerol for 15 minutes to 120 minutes. A vacuum of about 0.1-0.3 bar is maintained over the solution for 5 minutes during immersion. The krill are then removed and placed on a screen for 15 minutes to 120 minutes to allow excess glycerol to drip off into a recovery basin. The drip-dried impregnated krill are then packaged and placed in a standard freezer and cooled to −15° C.

### Example 2

### Impregnating Whole Raw Marine Worms Using 50% Glycerol Solution

Drip dried fresh whole raw marine worms are placed into a batch of cold 50% glycerol/50% water for 15 minutes to 120 minutes. A vacuum of about 0.1-0.3 bar is maintained over the solution for 5 minutes during immersion. The worms are then removed and placed on a screen for 15 minutes to 120 minutes to allow excess glycerol to drip off into a recovery basin. The drip-dried impregnated worms are then passed through a freezer tunnel and cooled to −15° C. The impregnated worms are then packaged.

### Example 3

### Impregnating Macro-Algae Using 50% Glycerol Solution

One or more species of Macro-Algae are placed into a bath of 50 wt % glycerol 50 wt % propylene glycol for a period of 15 minutes to 120 minutes. A vacuum of about 0.1-0.3 bar is maintained over the solution for 5 minutes during immersion. The algae is then removed and placed on a screen to drip off the excess solution. The impregnated algae is then packaged and cooled to −15° C. in a standard freezer.

### Example 4

### Impregnating a Formulated Feed Using 100% Glycerol Solution Under Vacuum

Formulated feed particles are placed into a bath of 80° F., 90% glycerol solution and a vacuum of 0.1 bar is pulled over the solution. The feed is maintained in the glycerol under vacuum for a period of about 15 minutes to 120 minutes. The vacuum is then removed and the feed is then withdrawn from the glycerol and placed on a screen for 15 minutes to 120 minutes to allow excess glycerol to drip off into a recovery basin. The drip-dried impregnated, coated feed is then cooled to −15° C. using a tunnel freezer and packaged.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method of preserving an aquatic animal food to maintain a ready to use condition directly from frozen storage, comprising:
immersing the aquatic animal food into a propane polyol containing solution and maintaining the in the solution for a period of time sufficient to form propane polyol coated and impregnated aquatic animal food;
removing the propane polyol coated and impregnated aquatic animal food from the propane polyol containing solution; and
cooling the propane polyol coated and impregnated aquatic animal food, wherein the propane polyol coated and impregnated aquatic animal food remains pliable when cooled to a temperature −15° C.

2. The method of claim 1, wherein the immersing is for a period of about 15 minutes to about two hours.

3. The method of claim 1, wherein the propane polyol containing solution includes at least one of glycerol and propylene glycol.

4. The method of claim 1, wherein the impregnated seafood comprises 1 wt % to about 20 wt % the propane polyol.

5. The method of claim 1, wherein the aquatic animal food is selected from the group consisting of krill, shrimp, brine shrimp, eggs, embryos, fish, mollusk, bivalves, plankton, macro-algae, polycheates, seaweed, crustaceans, worms, formulated feed and combinations thereof.

6. The method of claim 5, wherein the aquatic animal food is krill.

7. The method of claim 1, wherein the aquatic animal food is a formulated feed.

8. The method of claim 1, wherein the aquatic animal food is unblanched.

9. The method of claim 1, wherein the propane polyol containing solution further includes a flavor enhancer selected from the group consisting of betaine hydrochloride, free amino acids, fish hydrosylates, and combinations thereof.

10. The method of claim 1, further comprising packaging the impregnated aquatic animal food prior to cooling the impregnated aquatic animal food.

11. The method of claim of claim 1, wherein the cooling is done using standard freezing techniques.

12. The method of claim 1, further comprising subjecting the propane polyol impregnated aquatic animal food to vacuum simultaneously or subsequent to immersing but before cooling.

13. A preserved aquatic animal food product prepared by the method of claim 1.

14. The preserved aquatic animal food product of claim 13, wherein the animal food product is krill.

15. The preserved aquatic animal food product of claim 13, wherein the animal food product can be safely fed to an animal without thawing.

16. The preserved aquatic animal food product of claim 13, wherein the animal food product includes a flavor enhancer.

17. The preserved aquatic animal food product of claim 13, wherein the impregnated and coated animal food comprises 1 wt % to 20 wt % propane polyol.

18. The preserved aquatic animal food product of claim 13, wherein the aquatic animal food is selected from the group consisting of krill, shrimp, brine shrimp, eggs, embryos, fish, mollusk, bivalves, plankton, crustaceans, worms, formulated feed and combinations thereof.

19. The preserved aquatic animal food product of claim 13, wherein the animal food is krill.

20. The preserved aquatic animal food product of claim 13, wherein the impregnated animal food further includes a flavor enhancer selected from the group consisting of betaine hydrochloride, free amino acids, fish hydrosylates, and combinations thereof.
